(19) United States
(12) Patent Application Publication
(10) Pub. No.: US 2005/0076343 A1
(43) Pub. Date: Apr. 7, 2005

(54) Persistent storage of network management data using object references

(76) Inventor: Wolfgang Kammhuber, Munchen (DE)

Correspondence Address: Siemens Corporation;Intellectual Property Department, 170 Wood Avenue South, Iselin, NJ, 08830, US

(21) Appl. No.: 10/499,952

(22) PCT Filed: Dec. 17, 2002
(86) PCT No.: PCT/DE02/04618

(30) Foreign Application Priority Data
Dec. 21, 2001 (DE) 101 63 533.8

(51) Int. Cl. G06F 3/00

(52) U.S. Cl. 719/316

(57) ABSTRACT

The invention relates to a method for managing a network comprising a plurality of network components, and to a corresponding network management system. According to the invention, information about the network is persistently stored by filing object references in a database. Object references are used for the unambiguous identification of an object, and an object is a program representation of a network component, containing an executable program routine which, when called, emits data containing the information to be stored, as a return value. The program routine can be localized by-means of the respective filed object reference. The persistent storage of network management data by means of dynamic object references enables a network management program to access novel types or categories of objects, during its run-time, without necessitating an upgrade or a service interruption. The objects are preferably JAVA objects or EJB (Enterprise Java Beans) objects. Preferably, the implementation is carried out in CORBA. The database containing the object references is preferably a relational database.

### CROSS REFERENCE TO RELATED APPLICATIONS

This application is the US National Stage of International Application No. PCT/DE02/04618 filed Dec. 17, 2002 and claims the benefit thereof. The International Application claims the benefit of German application No. 10163533.8 filed Dec. 21, 2001, both of the applications are incorporated by reference herein in their entirety.

### FIELD OF INVENTION

This invention relates to networks comprising a plurality of network components, and is particularly concerned with the network management of such a network.

### BACKGROUND OF INVENTION

Networks such as computer networks are no longer merely supporting elements in a company, but are increasingly occupying a key position. The number of networked computers has always been rising fast in the past, and has sometimes increased rapidly, and the complexity and functionality of the components is also expanding in accordance with performance increases in the basic hardware.

Networks are often and increasingly structured heterogeneously. For example, modern, complex multi-service communication networks consist of many different network components, between which different relationships exist. Network components might be—for example—network elements such as routers and switches, but might also be communication profiles for protocols such as IP (Internet Protocol) and ATM (Asynchronous Transfer Mode), and physical and logical communication connections.

An example of a heterogeneous network is shown in FIG. 1a, in which network components 120, 130; 140 of different types A, B, C are connected together into a network. Network management systems 110 are used to ensure the operability of such a network.

The tasks of a network management system include—for example—maintaining services, availability, and response times, protecting the quality of service by monitoring the components, and carrying out preventive fault and bottleneck correction. Management systems are also required to respond automatically or semi-automatically to operating faults, whereby the configuration of the network is adjusted in real time in the event of a fault. Management systems might also be expected—for example—to activate redundant components in the event of a fault. Moreover, management systems must respond dynamically to changes in the network and network environment, for example with regard to applications, subscribers, components, services, and charges. It must, however, also be possible—for example—to make dynamic adjustments to transmission bandwidths.

Testing equipment is therefore also used as a network management tool, which can be used for testing the laid cables. Furthermore, network monitors are also used for monitoring and analyzing the data traffic on the network. More comprehensive network management facilities are provided by network management systems, which are based on defined network management standards such as SNMP (Simple Network Management Protocol).

Network management systems thus offer facilities for monitoring, administering and configuring networks from a central location, and thus also combine the functions of a network monitor and a network analysis tool. In terms of content, network management tasks can be divided into configuration management, fault management and performance management. Configuration management is used for displaying and manipulating different network components such as hub systems, bridges, and routers. Fault management is used for tracing, analysis and correction of faults, particularly in a heterogeneous environment. Thus, for example, protocol packets might be analyzed and the resulting data interpreted. Performance management supplies information about the efficiency of components and connections by continuous analysis of the network.

In order to fulfill these requirements, programs for management of networks must know the general topology and the statuses of the network. For example, network management might involve the task of analyzing and configuring an end-to-end connection. Such a connection is shown in FIG. 1b, where the physical units of such a network are indicated between end points 160. As can be seen from the diagram, different network components of various types A, B, C are divided into different subnetworks 170, 180, 190, which are also known as domains. Thus in this example a network connection between the end points 160 takes place via different domains containing different types of network components, which are interconnected by different types of physical and logical links and may also adhere to different protocols. If a network management system is to manage such an end-to-end connection, therefore, it must be able to retrieve all information about the network resources.

Since most networks are in place for longer than the average lifetime of a management program, the data that contains this information about network resources must be persistently stored outside the programs so that it can be read in again at a later date. Persistent storage in this context means the non-volatile filing of information in a memory that records the swapped-out data inside itself for a fairly long time. Persistent storage may essentially be carried out on the computer 110 on which the network management program is running. The data may, however, also be stored on a different network computer 120, 130, 140, in which case the network management program on the computer 110 must have resources available for accessing this persistently stored data.

Problems with conventional network management systems often arise as a result of the rapid and dynamic further development in network technologies, and the constant expansion in networks that results from this. These expansions may be either quantitative or qualitative, i.e. they may result not only from the addition of further network components and subscribers, but also from the addition of novel types of network component and/or from the modification from existing types to new types. Network expansion is illustrated in FIG. 1a, in which an existing network is expanded by a network component 150 of a novel type N. This produces the following problems.

since the network management station 110 can only monitor, administer, analyze and configure the network if it has access to all necessary information about the components contained in the network, the system must be able to retrieve the relevant information from the components or from elsewhere. Thus, if a new component of a previously unknown type N is added, the network management system cannot retrieve information about this component since the network management program does not yet have any means of querying the information relating to the novel type N. The network management program must therefore be expanded by the addition of a corresponding module that has been set up for communication with network components of type N.

A further problem results from the fact that each network component supplies or may supply data in a different data format. If a novel component is added to the network, the network management program must therefore file this data in a separate memory or supplement the existing memory by adding data fields in the new format. This means that no modifications in the persistent storage are required, which are costly and may even necessitate a reimplementation.

The above mentioned problems occur not only when a novel component is added, but also when a novel protocol is activated or when existing components or protocols are modified.

Thus, until now, the qualitative expansion of network technologies has usually necessitated considerable cost as the result of upgrading the existing network management solutions or from the costly synchronization of the entire management system and its persistent data. Qualitative expansion of the network normally requires the replacement of program versions, whereby such programs often have to be replaced even though they are not being expanded functionally, since they would no longer interoperate with the expanded objects without adjustment of the code. The program replacement thus necessary in the prior art therefore results in undesirable and cost-intensive interruptions to operation.

### SUMMARY OF INVENTION

The object of the invention is therefore to propose a method for managing a network, and a network management system, that permits qualitative modifications to be registered, evaluated and implemented in the network without operation being interrupted.

This object is achieved by the invention described in the claims.

According to the invention, object references are used for persistent storage of network management data. These object references are normally used for defining the network management data generically. Since the management system stores references, it can also store references to such objects that were unknown at the time when the network management program was produced. In this way, any number of objects of different object types (classes), even those that are referenced to one another, can be swapped out entirely generically to a persistent memory and read back in from there, without any modification to the existing program code being required. Modifications to the data model can consequently be carried out completely transparently for existing programs, so that it is not necessary for the operation of active programs to be interrupted.

Preferred embodiments of the invention are specified in the subclaims.

The implementation of the invention by means of object-oriented programming permits the storage of references in an abstract, standardized data model. This is beneficial not only in order to obtain maximum operating security, but also because it permits existing programming mechanisms to be used easily.

### BRIEF DESCRIPTION OF THE DRAWINGS

To permit a more detailed description of exemplary embodiments of the invention, reference is made below to the diagrams in which:

FIG. 1a illustrates a heterogeneous network with a network management station and a network component of a novel type;

FIG. 1b illustrates the physical components of an end-to-end connection with several domains;

FIG. 2 shows the elements of a network management system in a preferred embodiment of the invention;

FIG. 3 is a flow-chart of the process for reconstructing an object from a reference according to a preferred embodiment of the invention, and

FIG. 4 is a flow-chart of a process for defining the description of a network.

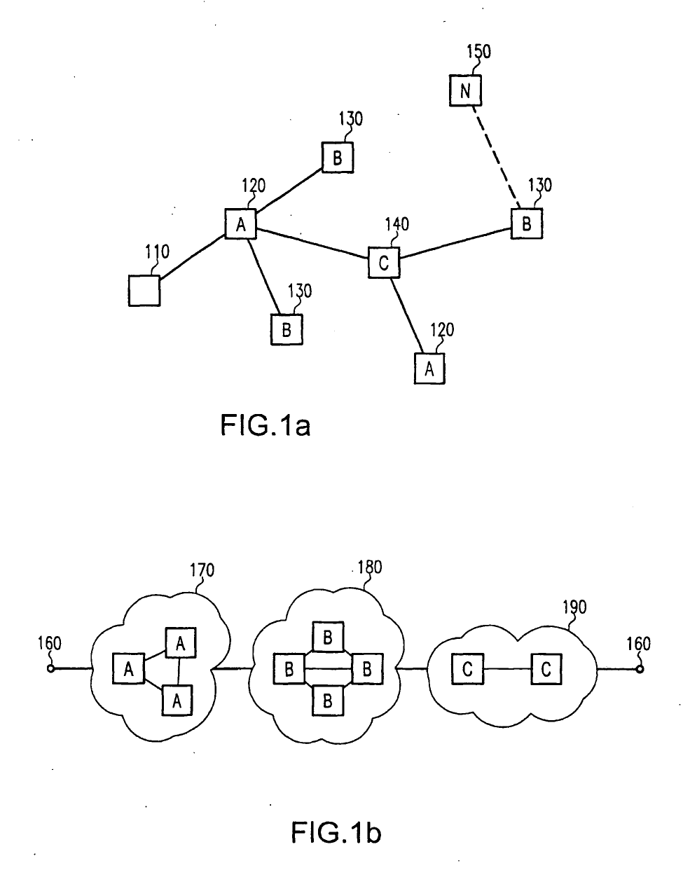

### DETAILED DESCRIPTION OF INVENTION

The invention will now be explained in greater detail with reference to the diagrams.

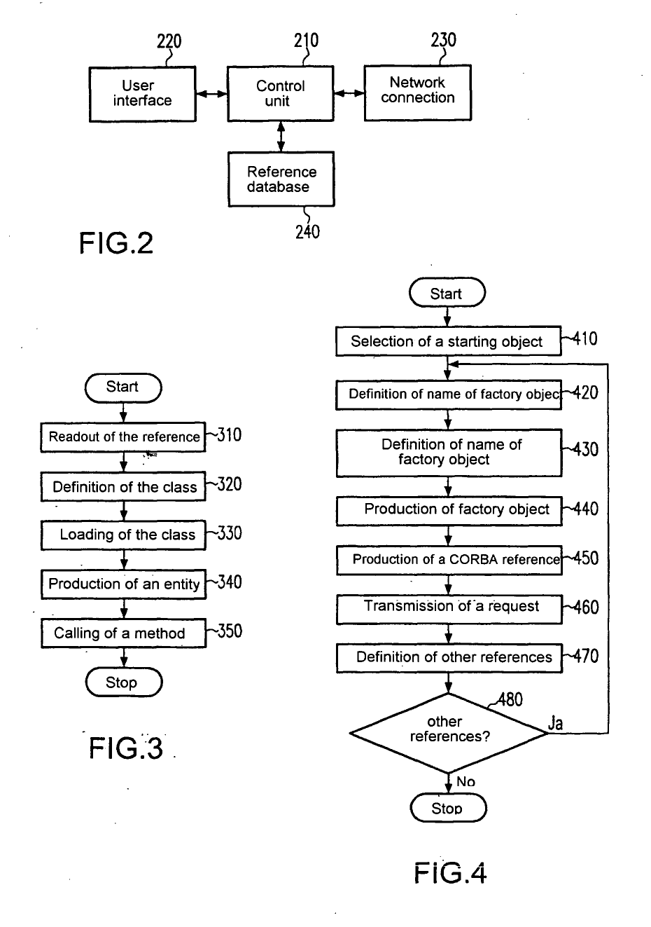

FIG. 2 shows the basic components of a network management station 110 according to a preferred embodiment of the present invention. A central control unit 210 is connected to a user interface 220. The user interface permits the operator to control the network management data. The control unit 210 is also connected to a network unit 230, via which the link to the network is effected. A reference database 240 is also provided, which persistently stores the references. The reference database is ideally a relational database.

Although the exemplary embodiment in FIG. 2 shows the reference database 240 as being connected to the control unit 210, in another preferred embodiment of the invention the reference database 240 may be stored on a network computer. Access to the persistently stored references is then effected by means of the control unit 210, via the network connection 230.

The references filed in the reference database 240 refer to objects. An object is the program representation of a physical device in a network, for example an IP router or a telephone exchange. An object may also represent a defined component or a module from such a physical device, such as—for example—a network component or a connection socket. Moreover, an object may also represent a physical or logical connection line for the transmission of messages (e.g. a cable). An object may also represent abstract logical data such as domains and end points, as well as connections of resources or communication paths.

Objects are preferably implemented by an object-oriented programming language such as Java. In this case objects can be formed by one or more Java classes or by EJB (EnterpriseJavaBeans), or by a CORBA object and corresponding stub utility classes for communication. Another form of object implementation can be achieved by appropriately selecting the database scheme of the reference database 240 for persistent storage.

A reference is used for the unambiguous identification of an object, which is used by another object for a specific purpose and/or which is related to it in a specific way. Such a relationship may, for example, consist in that one object is contained within another object. A reference may refer to objects of different classes (object types), and contains all information for accessing the persistently stored data. This is achieved in that a reference contains the class name of the referenced object and a reference to the persistent storage location of objects of the referenced class, thus—for example—to the database table used in a relational database. A reference thus contains the key to accessing the persistently stored attributes of the referenced object.

Dynamic object references, which can be applied in systems with distributed objects, e.g. CORBA and EJB, are preferably used. It is necessary here to distinguish between the client (the user of a service) and the server (the supplier of the service). A single program may simultaneously act as client for one service and as the server for another service. A program may also be a method of an object.

The content of the references is analyzed interpretatively by the program at runtime. According to a preferred embodiment of the invention, references are generically constructed, whereby the network
management program recognizes the generic construction. The reference contains no further semantic information about the content, and therefore—for example—no information about the data structure of the class of the object referenced. Thus the network management project is also able to handle such references that refer to the objects of novel classes that were not yet known at the time when the program was produced.

In a preferred embodiment of the invention, references are always of the same data type at program runtime. References are preferably persistently stored in a database field as a string.

A preferred construction of a reference consists of the Java class name and an unambiguous identification code, which clearly differentiates between the various entities of the class, i.e. the objects. If—for example—the classes Network and GateNE are present, then the references might be Network_{—}1, Network_{—}2, GateNE_IPRouter_{—}1, GateNE_IPRouter_{—}2, etc.

The reference thus contains all information necessary for reconstructing the object. An object is then only ever reconstructed from a reference if one or more methods of an object are to be called. Methods are executable program routines that are part of the corresponding object. The code that calls the methods on the referenced object, i.e. the program running on the client, uses the new class in the server, which is still unknown at programming time. It interprets the reference attribute of the type string by applying a naming convention at program runtime and uses the appropriate programming language resource to load the new classes and then to address methods of the objects on the server.

FIG. 3 is a flow-chart that illustrates this process in greater detail. Firstly, the control unit 210 reads out a reference from the reference database 240 in stage 310. A reference may alternatively also result from a method of a different object being called. In this case the class of the reference object is defined at runtime in stage 320. In the above example, this is done by evaluation of the reference string that contains the class name.

The class is now loaded. (stage 330), likewise at runtime. In the Java programming language, for example, this is facilitated by the so-called Reflection API and the integrated ClassLoader. In stage 340, then, the referenced object is generated at runtime as an entity of the defined and loaded class. Finally, in stage 350 one or more methods of the generated entities are called at runtime.

An example is now explained in greater detail with reference to FIG. 4, to show how the aforementioned method for managing a network can be implemented for a network. The flow-chart shown in FIG. 4 shows a process by which the client program is to define a description of the network. In the example, the network is described only by the following classes for the purpose of simplification:
Class IPRouter:
   Method getNextHop( )
   Method getDescription( )
Class LanSwitch:
   Method getNextHop( )
   Method getDescription( )

The two classes IPRouter and LanSwitch implement the methods getNextHop( ) and getDescription( ) respectively getNexHop( ) delivers one or more references to the objects that are logically connected to the current object. getDescription( ) delivers a description of the current object.

In the process shown in FIG. 4, the program starts in stage 410 with the selection of a starting object, for example on the basis of a known object in the network, for which the reference can be entered by the operator. The operator may enter the reference, for example, by directly inputting the reference string if it is known. Alternatively, the operator may select an object on a user interface, e.g. with a mouse. In this case the reference string must then be read out from the reference database 240.

In stage 420, in the alternative procedure mentioned, the reference string for the selected starting object is read out from the reference database 240. The name of the factory object (J2EE=Home Interface) is then defined from the reference string by application of the naming convention. Thus, with reference to the above examples, the name IPRouterHome of the factory object is defined as the string from IPRouter_{—}2. In a different example, the factory name LanSwitchHome is obtained from LanSwitch_{—}1111. If the class of the defined factory object is unknown, the program is terminated and/or a new reference is queried.

After the name of the factory object has been defined in this way in stage 430, the factory object is produced using the Reflection API.
ObjectfObject=Class.forName (factoryName)

Then, in stage 450, a CORBA reference to the object is produced by calling the method findByPrimaryKey( ).
Object rObjectRemote=fObject.findByPrimaryKey(refString)

If the CORBA object being searched for does not yet exist in the server, it is loaded into the server from the database.

Now, in stage 460, a request is transmitted from the client to the service. For this purpose only a stub is addressed in the client (via rObjectRemote). In the server the call is diverted to the concrete implementation of the class. The server knows the persistent storage location of the data describing the network and has the necessary resources to produce the server object from the contents of the database.

The server object produced may now be used, in stage 470, to retrieve the required methods.
rObjectRemote.invoke(“getDescription”, etc.)
rObjectRemote.invoke(“getNextHop”, etc.)

With the result of getNextHop( ), which normally delivers a number of references, the client can find all objects that describe the network by repeated application of stages 420 to 470. For this purpose, the process provides a branch 480 which arranges for the aforementioned stages to be repeated if no other references are available.

The preferred exemplary embodiment described above thus provides a possibility for managing a network by persistent storage of dynamic object references. Since, in this instance, the methods getDescription( ) and getNextHop( ) can be localized only by means of the respective filed object references (and the respective method names), persistent storage of class-related data is not necessary. The application of dynamic object references thus enables the implementation of a server to be replaced or removed for a service, or further servers to be added, without the need for any modification, reprogramming, retranslation, upgrading, or restarting of the active client programs.

Instead, only measures outside of the network management program are required if—for example—a new class of objects that require a completely new type of NextHop( ) implementation, is imported into the system during the program runtime. If, for example, objects in a class ATMSwitch, which does not yet exist in the network, are added to said network, the implementation of the class ATMSwitch and its stub classes must be imported at the server computer and loaded into the server, for example by means of deployment in Java EJB. Entities of the class ATMSwitch must then be produced in the server and references to the produced objects must be added in several of the existing objects.

Only stub classes of ATMSwitch need to be imported into the class loader path on the client computer. However, no modification of the network management program or data format of the persistent storage is necessary. The network management program may therefore use the new objects without operation being interrupted.

1-18. (canceled)

19. A Method for managing a network comprising a plurality of network components, the method comprising:
retrieving data, describing the network;
providing in the data, describing the network, information about network components in the network; and
storing the retrieved information in a persistent data storage;
wherein the retrieved information is stored by filing object references in a database,
wherein an object reference is an unambiguous identification of an object,
wherein an object is a program representation of a network component, comprising an executable program routine which, when called, emits data containing the information to be stored, as a return value, and
wherein the program routine is accessible by the respective filed object reference.

20. The Method according to claim 19, wherein
referenced objects are classified into classes according to their object type, and wherein
the object references comprise the name of the class of the object referenced respectively.

21. The Method according to claim 19, wherein the object references also comprise an identification code which unambiguously identifies the object of the relevant class as an entity of the class.

22. The Method according to claim 19, wherein the object references data type is string and they are based on a construction that permits the class name to be extracted from the reference string on the basis of its position.

23. The Method according to claim 19, wherein the data, that is emitted as a return value by the program routine, comprises further object references.

24. The Method according to claim 19, wherein a network component is a physical device in the network.

25. The Method according to claim 19, wherein a network component is a component or a module of a physical device in the network.

26. The Method according to claim 19, wherein a network component is a physical and/or logical communication connection.

27. The Method according to claim 19, wherein a network component is a domain, an end point, or another logical network unit.

28. The Method according to claim 19, wherein a network component is a communication profile for protocols.

29. The Method according to claim 19, wherein the program representation is a Java representation.

30. The Method according to claim 19, wherein the program representation is an EJB representation.

31. The Method according to claim 19, wherein the program routine can be localized by the respective filed object reference in a CORBA implementation.

32. The Method according to claim 19, wherein the objects can be implemented by the database scheme of a relational database.

33. The Method according to claim 19, wherein the retrieving data step comprises:
reading out an object reference;
defining the class of the referenced object;
loading the defined class;
producing an entity of the loaded class; and
calling the program routine for the produced entity.

34. The Method according to claim 19, further comprising
adapting the method to a network component of a new type, wherein this comprises:
implementing a class that represents the new type, in a server;
producing of objects as entities of the new class in the server;
adding references to the produced objects in at least one of the existing objects; and
importing stub classes of the new classes into the class loader path of a client.

35. The Method according to claim 19, wherein the retrieving data step comprises retrieving data describing the network, from at least one network component.

36. The Method according to claim 19, wherein the retrieving data step comprises
retrieving data describing the network, by at least one network component.

37. A Network management system for managing a network comprising a plurality of network components, comprising:
a device for querying data, describing the network, from at least one network component, wherein the data describing the network comprises information about network components the network comprises; and
a memory for the persistent storage of the retrieved information by filing of object references in a database, wherein an object reference is an unambiguous identification of an object, wherein
an object is a program representation of a network component,
containing an executable program routine which, when called, emits data comprising the information to be stored, as a return value, wherein the program routine can be localized solely by the respective filed object reference.

38. A Method for managing a network comprising a plurality of network components, the method comprising:
retrieving data, describing the network;
providing in the data, describing the network, information about network components in the network; and
storing the retrieved information in a persistent data storage, wherein
storing the retrieved information comprises filing object references in a database, wherein
an object reference is used for the unambiguous identification of an object, wherein
an object is a program representation of a network component, comprising an executable program routine which, when called, emits data containing the information to be stored, as a return value, and wherein
a program routine can be localized by the respective filed object reference.
